(19) United States
(12) Patent Application Publication
(10) Pub. No.: US 2023/0382751 A1
(43) Pub. Date: Nov. 30, 2023

(54) PREVENTING DECOMPOSITION IN SODIUM CYANIDE COMPOSITIONS

(71) Applicant: CYANCO CORPORATION, Sugar Land, TX (US)

(72) Inventors: Michael Lefenfeld, Sugar Land, TX (US); Justin Manganaro, Sugar Land, TX (US); Roy Norcross, Sugar Land, TX (US)

(21) Appl. No.: 18/310,945

(22) Filed: May 2, 2023

Related U.S. Application Data
(60) Provisional application No. 63/337,231, filed on May 2, 2022.

(51) Int. Cl. C01C 3/10

(52) U.S. Cl. CPC C01C 3/10

(57) ABSTRACT

This invention relates to a method for reducing decomposition of an aqueous sodium cyanide solution by passing an inert gas through the aqueous sodium cyanide solution to remove carbon dioxide from the solution, and/or storing the aqueous sodium cyanide solution under an inert gas or under a vacuum. This invention also relates to a method for reducing decomposition of a sodium cyanide slurry, a sodium cyanide paste, or a solid sodium cyanide composition by storing the sodium cyanide paste, the sodium cyanide slurry, or the solid sodium cyanide under an inert gas or under a vacuum.

### CROSS-REFERENCE TO RELATED APPLICATION

This application claims priority to U.S. Provisional Application No. 63/337,231, filed on May 2, 2022, the disclosure of which is incorporated herein by reference.

### TECHNICAL FIELD

This invention relates to a method for reducing decomposition of an aqueous sodium cyanide solution.

This invention also relates to a method for reducing decomposition of a sodium cyanide slurry, a sodium cyanide paste, or a solid sodium cyanide composition.

### BACKGROUND OF THE INVENTION

Sodium cyanide is produced via the absorption of hydrogen cyanide gases into an aqueous sodium hydroxide solution or the reaction of liquified hydrogen cyanide with aqueous sodium hydroxide solution. Sodium cyanide is a commodity chemical used in the mining industry to extract gold and silver from ore. It is sold either as an aqueous solution, typically between 25 and 35% sodium cyanide by weight, or as a solid between 97 and 99% purity. Aqueous sodium cyanide slurries are also used. See, for example, U.S. Pat. No. 4,902,301. The formation of contaminants, including sodium carbonate and sodium formate, proceed over time reducing the content of sodium cyanide in solution. It is believed that these contaminants result from a reaction of the cyanide in solution with dissolved carbon dioxide and/or from carbon dioxide absorbed from the atmosphere.

In the production of sodium cyanide, contaminants such as sodium carbonate and sodium formate are known impurities. See U.S. Pat. No. 4,847,062. Other patents describe separation techniques for such impurities. See US 2010/0296995 and U.S. Pat. No. 3,273,959. These techniques are typically involved in the production of sodium cyanide solids as the newly formed pure solution is used as the feed ingredient and can be processed immediately. However, such techniques are capital intensive and are only temporary, as carbonate and formate contaminants will continue to form after separation whether the sodium cyanide is in the form of a solid, a paste, or a slurry or is in solution.

The formation of these contaminants not only makes storage of solid sodium cyanide problematic, it also impacts the delivery of solution as the customer will see less cyanide than what was discharged by the production facility. Significant loss of sodium cyanide in the solution occurs during storage and transport. Also, the degradation of product can evolve ammonia, which is toxic and harmful to those who are exposed to it.

Therefore, there is a need for a method that reduces the contaminants that build up in a sodium cyanide composition allowing for the production and delivery of a high purity sodium cyanide product by reducing the quantity of cyanide that is loss to degradation.

### SUMMARY OF THE INVENTION

This invention relates to methods of reducing the quantity of sodium cyanide that is loss to degradation. It significantly reduces the contaminants that build up in a sodium cyanide composition allowing for the production and delivery of a high purity sodium cyanide product. This invention eliminates the need for a capital-intensive separation process.

### DESCRIPTION OF THE INVENTION

The invention relates to methods for reducing decomposition of an aqueous sodium cyanide solution. The invention also relates to methods for reducing cyanide decomposition in an aqueous sodium cyanide slurry, an aqueous sodium cyanide paste, or in a solid sodium cyanide composition. The aqueous medium is preferably water itself. The methods of the invention reduce cyanide decomposition by more than 50%, more than 70%, more than 90%, or more than 95% and preferably substantially prevent decomposition.

A method of the invention comprises the steps of passing an inert gas through an aqueous sodium cyanide solution to remove carbon dioxide from the solution, and/or storing an aqueous sodium cyanide solution under an inert gas or under a vacuum. In one embodiment of the invention, the inert gas is passed through the aqueous sodium cyanide solution via bubbling. When a solution is stored under a vacuum the pressure in the container, at least at the time of storage, is a reduced pressure below atmospheric pressure.

The aqueous sodium cyanide solution, or solid sodium cyanide, may contain any amount of sodium cyanide. Commercial scale aqueous sodium cyanide solutions contain about 15 to 45 wt. % sodium cyanide, and more typically about 25 to 35 wt. % sodium cyanide. The inert gas is any gas generally recognized as inert in chemical reactions. Such gases include, but are not limited to, gases selected from the group consisting of nitrogen, argon, methane, natural gas, hydrogen, steam, helium, ammonia, oxygen, and mixtures thereof. Any gases which do not react with cyanide, or which do not lead to decomposition of cyanide, may also be inert gases for the purposes of the invention.

An inert gas may be bubbled through an aqueous sodium cyanide solution using means known in the art. With a method of the invention, all, or substantially all (e.g., >50%, >60%, >70%, >80%, >90%, >95%, >96%, >97%, >98%, >99%, >99.9%), carbon dioxide is preferably removed from the solution or surrounding atmosphere. Enough carbon dioxide should be removed to prevent, or at least minimize, decomposition.

The inert gas may be bubbled through a sodium cyanide solution via a sparger/injector below the liquid level. This process can be completed using a number of locations throughout the sodium cyanide manufacturing process, including but not limited to the absorber column, disengagement vessel, sodium cyanide recirculation lines, and sodium cyanide product to storage pipeline. The invention may also be implemented via sparging the inert gas through the solution while contained in a storage vessel, or while being loaded into transport vessel, or while in the transport vessel. Once dissolved carbon dioxide is removed from the solution, carbon dioxide should preferably be removed from the interface between solution and gas, the headspace in a container holding the solution. This may be completed by either creating a vacuum (via steam ejector or other means) or by introducing an inert gas to blanket the solution stored in process equipment, storage vessels and transport vessels.

When storing an aqueous sodium cyanide solution or solid form sodium cyanide under an inert gas, the inert gases are introduced in the head space of the container containing the solution. This may be performed as a function of bubbling the inert gas through the solution or by introducing the inert gas directly into the head space. Sufficient inert gas should be used to preferably displace carbon dioxide containing gas in the head space or dissolved in the aqueous solution, or to reduce the concentration of carbon dioxide in the head space such decomposition is prevented or minimized.

Removing carbon dioxide from an aqueous sodium cyanide solution according to a method of the invention results in an aqueous sodium cyanide solution containing an inert gas and substantially no carbon dioxide or an aqueous sodium cyanide solution stored under an inert gas. These are separate embodiments of the invention. Preferably, the aqueous sodium cyanide solution is one containing an inert gas and substantially no carbon dioxide and stored under an inert gas.

The invention also provides methods for reducing decomposition of a sodium cyanide paste, a sodium cyanide slurry, or solid sodium cyanide. Such methods store a sodium cyanide paste, a sodium cyanide slurry, or solid sodium cyanide under an inert gas or under a vacuum. The inert gas used in these methods is the same as those discussed above. The sodium cyanide paste, the sodium cyanide slurry, or solid sodium usually contains about 25 to 100 wt. % sodium cyanide. Typically, a sodium cyanide paste or slurry is an aqueous-based paste or slurry. Prior to forming the paste or slurry, carbon dioxide may be removed from the aqueous portion by bubbling with an inert gas before mixing with the sodium cyanide. These methods of the invention produce a sodium cyanide paste, a sodium cyanide slurry, or solid sodium cyanide stored under an inert gas or under a vacuum as discussed above, each of which are separate embodiments of the invention.

When a sodium cyanide paste, a sodium cyanide slurry, or solid sodium cyanide is stored under a vacuum the pressure in the container, at least at the time of storage, is a reduced pressure below atmospheric pressure. An inert gas may be bubbled through the aqueous portion using means known in the art. With a method of the invention, all, or substantially all (e.g., >50%, >60%, >70%, >80%, >90%, >95%, >96%, >97%, >98%, >99%, >99.9%), carbon dioxide is preferably removed from the sodium cyanide paste, the sodium cyanide slurry, or the solid sodium cyanide or surrounding atmosphere. Enough carbon dioxide should be removed to prevent, or at least minimize, decomposition. Carbon dioxide may be removed by either creating a vacuum (via steam ejector or other means) or by introducing an inert gas to blanket the solution stored in process equipment, storage vessels and transport vessels.

Removing carbon dioxide from a sodium cyanide paste, a sodium cyanide slurry, or solid sodium cyanide according to a method of the invention results in a sodium cyanide paste, a sodium cyanide slurry, or solid sodium cyanide containing an inert gas and substantially no carbon dioxide or a sodium cyanide paste, a sodium cyanide slurry, or solid sodium cyanide stored under an inert gas. These are separate embodiments of the invention. Preferably, the sodium cyanide paste, the sodium cyanide slurry, or the solid sodium cyanide is one containing an inert gas and substantially no carbon dioxide and stored under an inert gas.

The invention also relates to a method for preparing a slurry or paste of sodium cyanide in an aqueous system. The method comprises the steps of passing an inert gas through an aqueous solvent to remove carbon dioxide, combining sodium cyanide with the aqueous solvent having the carbon dioxide removed to form an aqueous slurry or paste of sodium cyanide, optionally dehydrating the aqueous slurry or paste of sodium cyanide to remove water from the slurry or paste, and/or storing the aqueous sodium cyanide slurry or paste under an inert gas or under a vacuum. In one embodiment of the invention, the inert gas is passed through the aqueous sodium cyanide solution via bubbling. The aqueous solvent is preferably water itself. The inert gas may be bubbled through the aqueous system via a sparger/injector as described above with regard to an aqueous solution of sodium cyanide.

The inert gas is any gas generally recognized as inert in chemical reactions. Such gases include, but are not limited to, gases selected from the group consisting of nitrogen, argon, methane, natural gas, hydrogen, steam, helium, ammonia, oxygen, and mixtures thereof. Any gases which do not react with cyanide, or which do not lead to decomposition of cyanide, may also be inert gases for the purposes of the invention. When a sodium cyanide paste or a sodium cyanide slurry is stored under a vacuum the pressure in the container, at least at the time of storage, is a reduced pressure below atmospheric pressure.

The invention also relates to an aqueous sodium cyanide solution containing an inert gas and substantially no carbon dioxide. The aqueous sodium cyanide solution is stored under an inert gas or under a vacuum.

The invention also relates to an aqueous sodium cyanide solution stored under an inert gas or under a vacuum.

The invention also relates to a sodium cyanide paste, a sodium cyanide slurry, or solid sodium cyanide stored under an inert gas or under a vacuum.

### EXEMPLARY EMBODIMENTS OF THE INVENTION

E1. A method for reducing decomposition of an aqueous sodium cyanide solution comprising the steps of:
passing an inert gas through the aqueous sodium cyanide solution to remove carbon dioxide from the solution, and/or
storing the aqueous sodium cyanide solution under an inert gas or under a vacuum.
E2. A method for reducing decomposition of an aqueous sodium cyanide solution comprising the step of:
storing an aqueous sodium cyanide solution under an inert gas or under a vacuum.
E3. The method of E1 or E2, wherein the inert gas is selected from the group consisting of nitrogen, argon, methane, natural gas, hydrogen, steam, helium, ammonia, oxygen, and mixtures thereof.
E4. The method of any one of E1-E3, wherein the aqueous sodium cyanide solution contains 15 to 45 wt. % sodium cyanide or the aqueous sodium cyanide solution contains 25 to 35 wt. % sodium cyanide.
E5. The method of any one of E1-E4, wherein an aqueous solvent of the aqueous sodium cyanide is water.
E6. The method of any one of E1-E5, wherein the decomposition of the aqueous sodium cyanide solution is reduced by more than 50%, more than 70%, more than 90%, or more than 95%.
E7. The method of any one of E1-E5, wherein the decomposition of the aqueous sodium cyanide solution is substantially prevented.
E8. The method of any one of E1-E7, wherein, when the aqueous sodium cyanide solution is stored under a vacuum, the pressure is below atmospheric pressure.
E9. The method of any one of E1-E8, wherein all or substantially all (e.g., >50%, >60%, >70%, >80%, >90%, >95%, >96%, >97%, >98%, >99%, >99.9%) of the carbon dioxide is removed from the solution.
E10. The method of any one of E1-E9, wherein the inert gas is bubbled via a sparger or injector below the liquid level.
E1. The method of E10, wherein the bubbling occurs in an absorber column, a disengagement vessel, a sodium cyanide recirculation line, or a sodium cyanide product to storage pipeline.
E12. The method of E10, wherein the bubbling occurs in a storage vessel, while loaded into a transport vessel, or while in the transport vessel.
E13. The method of any one of E1-E12, wherein the carbon dioxide is removed from the interface between solution and gas.
E14. The method of any one of E1-E13, wherein a blanket of the inert gas or the vacuum is used to remove the carbon dioxide.
E15. The method of any one of E1-E14, wherein sufficient inert gas is used to displace carbon dioxide containing gas in the headspace or dissolved in the aqueous sodium cyanide solution.
E16. The method of any one of E1-E14, wherein sufficient inert gas is used to reduce the concentration of carbon dioxide in the headspace.
E17. The method of any one of E1-E16, wherein the resulting aqueous sodium cyanide solution contains the inert gas and substantially no carbon dioxide.
E18. The method of any one of E1-E16, wherein the resulting aqueous sodium cyanide solution is stored under the inert gas.
E19. The method of any one of E1-E16, wherein the resulting aqueous sodium cyanide solution contains the inert gas, has substantially no carbon dioxide, and is stored under the inert gas.
E20. The method of any one of E1-E19, wherein the inert gas is passed through the aqueous sodium cyanide solution via bubbling.
E21. A method for reducing decomposition of a sodium cyanide paste, a sodium cyanide slurry, or solid sodium cyanide comprising the step of:
storing the sodium cyanide paste, the sodium cyanide slurry, or the solid sodium cyanide under an inert gas or under a vacuum.
E22. The method of E21, wherein the inert gas is selected from the group consisting of nitrogen, argon, methane, natural gas, hydrogen, steam, helium, ammonia, oxygen, and mixtures thereof.
E23. The method of E21 or E22, wherein the sodium cyanide paste, the sodium cyanide slurry, or the solid sodium cyanide comprises 25 to 100 wt. % sodium cyanide.
E24. The method of any one of E21-E23, wherein the sodium cyanide paste is an aqueous sodium cyanide paste.
E25. The method of any one of E21-E23, wherein the sodium cyanide slurry is an aqueous sodium cyanide slurry.
E26. The method of any one of E24 or E25, wherein an aqueous solvent of the aqueous sodium cyanide paste and aqueous sodium cyanide slurry is water.
E27. The method of any one of E24-E26, wherein prior to forming the aqueous sodium cyanide paste or the aqueous sodium cyanide slurry, carbon dioxide is removed from the aqueous portion by bubbling with an inert gas before mixing with the sodium cyanide.
E28. The method of any one of E21-E27, wherein the decomposition of the sodium cyanide paste, the sodium cyanide slurry, or the solid sodium cyanide is reduced by more than 50%, more than 70%, more than 90%, or more than 95%.
E29. The method of any one of E21-E27, wherein the decomposition of the sodium cyanide paste, the sodium cyanide slurry, or the solid sodium cyanide is substantially prevented.
E30. The method of any one of E21-E29, wherein the sodium cyanide paste, the sodium cyanide slurry, or the solid sodium cyanide is stored under a vacuum and the pressure is below atmospheric pressure.
E31. The method of any one of E21-E30, wherein all or substantially all (e.g., >50%, >60%, >70%, >80%, >90%, >95%, >96%, >97%, >98%, >99%, >99.9%) of the carbon dioxide is removed from the sodium cyanide paste, the sodium cyanide slurry, or the solid sodium cyanide.
E32. The method of any one of E21-E31, wherein a blanket of the inert gas or the vacuum is used to remove carbon dioxide.
E33. The method of any one of E21-E32, wherein the resulting sodium cyanide paste, sodium cyanide slurry, or solid sodium cyanide contains the inert gas and substantially no carbon dioxide.
E34. The method of any one of E21-E32, wherein the resulting sodium cyanide paste, sodium cyanide slurry, or solid sodium cyanide is stored under the inert gas.
E35. The method of any one of E21-E32, wherein the resulting sodium cyanide paste, sodium cyanide slurry, or solid sodium cyanide contains the inert gas, has substantially no carbon dioxide, and is stored under the inert gas.
E36. A method for preparing a slurry or a paste of sodium cyanide in an aqueous system comprising the steps of:
passing an inert gas through an aqueous solvent to remove carbon dioxide,
combining sodium cyanide with the aqueous solvent having the carbon dioxide removed to form an aqueous slurry or an aqueous paste of sodium cyanide,
optionally dehydrating the aqueous slurry or the aqueous paste of sodium cyanide to remove water from the slurry or the paste, and/or
storing the aqueous sodium cyanide slurry or the aqueous sodium cyanide paste under an inert gas or under a vacuum.
E37. The method of E36, wherein the aqueous solvent is water.
E38. The method of E36 or E37, wherein the inert gas is selected from the group consisting of nitrogen, argon, methane, natural gas, hydrogen, steam, helium, ammonia, oxygen, and mixtures thereof.
E39. The method of any one of E36-E38, wherein, when the aqueous sodium cyanide slurry or the aqueous sodium cyanide paste is stored under a vacuum, the pressure is below atmospheric pressure.
E40. The method of any one of E36-E39, wherein all or substantially all (e.g., >50%, >60%, >70%, >80%, >90%, >95%, >96%, >97%, >98%, >99%, >99.9%) of the carbon dioxide is removed from the aqueous system.
E41. The method of any one of E36-E40, wherein the inert gas is bubbled via a sparger or injector below the liquid level.
E42. The method of any one of E36-E41, wherein carbon dioxide is removed from the interface between solution and gas.
E43. The method of any one of E36-E42, wherein a blanket of the inert gas or the vacuum is used to remove carbon dioxide.
E44. The method of any one of E36-E43, wherein the resulting aqueous sodium cyanide slurry or aqueous sodium cyanide paste contains the inert gas and substantially no carbon dioxide.
E45. The method of any one of E36-E43, wherein the resulting aqueous sodium cyanide slurry or aqueous sodium cyanide paste is stored under the inert gas.
E46. The method of any one of E36-E43, wherein the resulting aqueous sodium cyanide slurry or aqueous sodium cyanide paste contains the inert gas, has substantially no carbon dioxide, and is stored under the inert gas.
E47. The method of any one of E36-E46, wherein the inert gas is passed through the aqueous sodium cyanide solution via bubbling.
E48. An aqueous sodium cyanide solution containing an inert gas and substantially no carbon dioxide.
E49. The aqueous sodium cyanide solution of E48 stored under an inert gas or under a vacuum.
E50. An aqueous sodium cyanide solution stored under an inert gas or under a vacuum.
E51. A sodium cyanide paste, a sodium cyanide slurry, or solid sodium cyanide stored under an inert gas or under a vacuum.

### EXAMPLES

### Example 1

A sodium cyanide solution (“Test”) of approximately 250 ml in a closed, but not completely sealed, beaker had nitrogen gas bubbled through it for 30 minutes, before a nitrogen blanket was applied. The solution was then subjected to a heat load, maintaining temperatures of, or about, 100° C. for 24 hours. This was compared to a baseline control solution (“Control”), where the same heat load was applied without the nitrogen gas bubbling and blanket steps.

The results, shown in Table 1 below, showed a decrease in cyanide losses of 74%. With initial concentrations of solution of 340 g/L the loss in the control sample was equivalent to 34%. This is significantly greater than the 9% loss experienced in the test sample.

TABLE 1

| Cyanide | Control | Test |
|---|---|---|
| Initial Concentration | 340 | 340 |
| Final Concentration (g/L) | 225 | 310 |
| Loss (g/L) | 115 | 30 |
| Loss (%) | 34% | 9% |

### Example 2: Impact of Solution Strength

A second solution (“Low Conc”) of approximately 250 ml in a closed, but not sealed tight system, and at a reduced concentration of sodium cyanide went through a similar process as the control, where a heat load was applied for 24 hours at about 100° C. This was compared to the control solution (“Control”), where the same heat load was applied without the bubbling and blanket process.

The results, shown in Table 2 below, showed an equivalent loss of cyanide in both the high concentration (Control) and low concentration (Low Conc) solutions. This leads to the conclusion that changes in cyanide strength has little impact to the losses of sodium cyanide through its decomposition processes.

TABLE 2

| Cyanide | Control | Low Conc |
|---|---|---|
| Initial Concentration (g/L) | 340 | 225 |
| Final Concentration (g/L) | 225 | 152 |
| Loss (g/L) | 115 | 73 |
| Loss (%) | 34% | 32% |

The claimed invention is:

1. A method for reducing decomposition of an aqueous sodium cyanide solution comprising the steps of:
passing an inert gas through the aqueous sodium cyanide solution to remove carbon dioxide from the solution, and/or
storing the aqueous sodium cyanide solution under an inert gas or under a vacuum.

2. A method for reducing decomposition of an aqueous sodium cyanide solution comprising the step of:
storing the aqueous sodium cyanide solution under an inert gas or under a vacuum.

3. The method of claim 1, wherein the inert gas is selected from the group consisting of nitrogen, argon, methane, natural gas, hydrogen, steam, helium, ammonia, oxygen, and mixtures thereof.

4. The method of claim 2, wherein the inert gas is selected from the group consisting of nitrogen, argon, methane, natural gas, hydrogen, steam, helium, ammonia, oxygen, and mixtures thereof.

5. The method of claim 1, wherein the aqueous sodium cyanide solution contains 15 to 45 wt. % sodium cyanide or the aqueous sodium cyanide solution contains 25 to 35 wt. % sodium cyanide.

6. The method of claim 2, wherein the aqueous sodium cyanide solution contains 15 to 45 wt. % sodium cyanide or the aqueous sodium cyanide solution contains 25 to 35 wt. % sodium cyanide.

7. The method of claim 1, wherein the decomposition of the aqueous sodium cyanide solution is reduced by more than 90%.

8. The method of claim 2, wherein the decomposition of the aqueous sodium cyanide solution is reduced by more than 90%.

9. The method of claim 1, wherein all or substantially all of the carbon dioxide is removed from the solution.

10. The method of claim 2, wherein all or substantially all of the carbon dioxide is removed from the solution.

11. A method for reducing decomposition of a sodium cyanide paste, a sodium cyanide slurry, or solid sodium cyanide comprising the step of:
storing the sodium cyanide paste, the sodium cyanide slurry, or the solid sodium cyanide under an inert gas or under a vacuum.

12. The method of claim 11, wherein the inert gas is selected from the group consisting of nitrogen, argon, methane, natural gas, hydrogen, steam, helium, ammonia, oxygen, and mixtures thereof.

13. The method of claim 11, wherein the sodium cyanide paste, the sodium cyanide slurry, or the solid sodium cyanide comprises 25 to 100 wt. % sodium cyanide.

14. The method of claim 11, wherein the decomposition of the aqueous sodium cyanide solution is reduced by more than 90%.

15. A method for preparing a slurry or a paste of sodium cyanide in an aqueous system comprising the steps of:
passing an inert gas through an aqueous solvent to remove carbon dioxide,
combining sodium cyanide with the aqueous solvent having the carbon dioxide removed to form an aqueous slurry or an aqueous paste of sodium cyanide,
optionally dehydrating the aqueous slurry or the aqueous paste of sodium cyanide to remove water from the slurry or the paste, and/or
storing the aqueous sodium cyanide slurry or the aqueous sodium cyanide paste under an inert gas or under a vacuum.

16. The method of claim 15, wherein the inert gas is selected from the group consisting of nitrogen, argon, methane, natural gas, hydrogen, steam, helium, ammonia, oxygen, and mixtures thereof.

17. An aqueous sodium cyanide solution containing an inert gas and substantially no carbon dioxide.

18. The aqueous sodium cyanide solution of claim 17 stored under an inert gas or under a vacuum.

19. An aqueous sodium cyanide solution stored under an inert gas or under a vacuum.

20. A sodium cyanide paste, a sodium cyanide slurry, or solid sodium cyanide stored under an inert gas or under a vacuum.
